(19) United States
(12) Patent Application Publication
(10) Pub. No.: US 2025/0300328 A1
(43) Pub. Date: Sep. 25, 2025

(54) CYLINDER TYPE RECHARGEABLE BATTERY

(71) Applicant: SAMSUNG SDI CO., LTD., Yongin-si (KR)

(72) Inventors: Sunggwi KO, Yongin-si (KR); Gungue PARK, Yongin-si (KR); Jaehyuck CHA, Yongin-si (KR)

(21) Appl. No.: 19/011,377

(22) Filed: Jan. 6, 2025

(30) Foreign Application Priority Data
Mar. 25, 2024 (KR) 10-2024-0040536

(51) Int. Cl. H01M 50/533; H01M 50/107

(52) U.S. Cl. CPC H01M 50/533; H01M 50/107

(57) ABSTRACT

A cylinder type rechargeable battery of the present disclosure includes: an electrode assembly; a case comprising a body portion and an inlet portion extending into the body portion and having a portion shaped as a plane, the case accommodating the electrode assembly; and a negative electrode current collecting plate comprising a base portion comprising a portion connected to the electrode assembly and a contact portion extending from an edge of the base portion toward the inlet portion and contacting the portion shaped as the plane of an inner surface of the case, the negative electrode current collecting plate being electrically connected to the electrode assembly.

### CROSS-REFERENCE TO RELATED APPLICATION

The present application claims priority to and the benefit of Korean Patent Application No. 10-2024-0040536, filed on Mar. 25, 2024 in the Korean Intellectual Property Office, the entire disclosure of which is incorporated herein by reference.

### BACKGROUND

### 1. Field

Aspects of embodiments of the present disclosure relate to a cylinder type rechargeable battery.

### 2. Description of the Related Art

A rechargeable battery is a battery that may be charged and discharged, unlike a primary battery that may not be charged. A low-capacity battery of the rechargeable battery in which one electrode assembly is packaged in a pack form may be used in a portable small electronic device, such as a mobile phone or a camcorder. A large-capacity battery of the rechargeable battery in which dozens of electrode assemblies, for example, are connected is widely used as a power source for driving a motor of an electric scooter, a hybrid vehicle, an electric vehicle, or the like.

The rechargeable battery may be manufactured in various shapes. A cylinder type rechargeable battery among the rechargeable battery includes an electrode assembly having a cylindrical shape, a can having a cylindrical shape accommodating the electrode assembly and an electrolyte, and a cap assembly coupled to an upper opening of the can to seal the can and allow a current generated in the electrode assembly to flow to an external device.

Some products among the cylinder type rechargeable battery have a structure having a negative electrode polarity and a positive electrode polarity at an upper portion thereof. Therefore, welding of a negative electrode current collecting plate and the can may be required, and a case and a current collecting plate may be welded inside the rechargeable battery. In this case, a foreign substance may be generated inside the case during the welding.

### SUMMARY

According to an aspect of embodiments of the present disclosure, a cylinder type rechargeable battery capable of preventing (preventing or substantially preventing) a foreign substance from occurring inside a case is provided.

According to one or more embodiments of the present disclosure, a cylinder type rechargeable battery includes: an electrode assembly; a case comprising a body portion and an inlet portion extending into the body portion and having a portion shaped as a plane, the case accommodating the electrode assembly; and a negative electrode current collecting plate comprising a base portion comprising a portion connected to the electrode assembly and a contact portion extending from an edge of the base portion toward the inlet portion and contacting the portion shaped as the plane of an inner surface of the case, the negative electrode current collecting plate being electrically connected to the electrode assembly.

The contact portion may include: a first elastic portion extending from an edge of the base portion toward the inlet portion; and a second elastic portion extending from the first elastic portion, contacting the portion shaped as a plane of the inlet portion, and covering at least a portion of the inlet portion.

Each of the first elastic portion and the second elastic portion may include or be formed of an elastically deformable material.

The negative electrode current collecting plate may further include a first through hole that is located at a central portion of the negative electrode current collecting plate and penetrates the base portion.

The cylinder type rechargeable battery may further include at least one second through hole that is located at an angle based on a central portion of the base portion and penetrates the base portion.

The at least one second through hole may have a slot shape.

The at least one second through hole may include four second through holes, and the four second through holes may be located at 90 degrees apart based on the central portion of the base portion.

The negative electrode current collecting plate may include at least one cutout portion that is cut from a portion of the base portion and is connected to a negative electrode plate of the electrode assembly.

The at least one cutout portion may include four cutout portions, and the four cutout portions may be located at 90 degrees apart based on a center of the base portion.

The cutout portion may be formed by cutting a portion of the base portion in a “U” shape.

The inlet portion of the case may include a first flat portion and a second flat portion that are located such that outer surfaces thereof face each other, and a connection portion that connects the first flat portion and the second flat portion.

The contact portion may have an arc shape.

In the cylinder type rechargeable battery according to embodiments of the present disclosure, a contact portion of a negative electrode current collecting plate may contact an inlet portion of a case to enable welding from the outside. Accordingly, because the welding is performed from the outside, a foreign substance may be prevented or substantially prevented from being generated inside the case. In addition, it is possible to prevent or substantially prevent a resistance of the cylinder type rechargeable battery from being increased by the foreign substance.

Therefore, it is possible to improve productivity and reduce a manufacturing cost by reducing a manufacturing defect rate of the cylinder type rechargeable battery.

### BRIEF DESCRIPTION OF THE DRAWINGS

FIG. 1 is a perspective view showing a cylinder type rechargeable battery according to one or more embodiments of the present disclosure.

FIG. 2 is a cross-sectional view showing the cylinder type rechargeable battery of FIG. 1.

FIG. 3 is a cross-sectional view showing a cylinder type rechargeable battery including an electrode assembly according to one or more embodiments.

FIG. 4 is a perspective view showing a case and a negative electrode current collecting plate extracted from the cylinder type rechargeable battery according to one or more embodiments of the present disclosure.

FIG. 5 is a cross-sectional view taken along the line V-V′ of the cylinder type rechargeable battery of FIG. 4.

FIG. 6 is a cross-sectional view showing the cylinder type rechargeable battery of FIG. 5.

FIG. 7 is an enlarged cross-sectional view of a region “A” of the cylinder type rechargeable battery of FIG. 5.

FIG. 8 is a plan view showing the negative electrode current collecting plate extracted from FIG. 4.

FIG. 9 is a cross-sectional view showing a negative electrode current collecting plate according to one or more embodiments of the present disclosure.

DESCRIPTION OF SYMBOLS

| | |
|---|---|
| 1000, 2000: cylinder type | |
| rechargeable battery | |
| 100: case | 120: body portion |
| 130: inlet portion | 131: first flat portion |
| 132: second flat portion | 133: connection portion |
| 200: electrode assembly | |
| 300: positive electrode | |
| current collecting plate | |
| 400A, 400B: negative electrode | |
| current collecting plate | |
| 410A: base portion | 420A, 420B: contact portion |
| 421B: first elastic portion | 422B: second elastic portion |
| 450A: first through hole | 460A: second through hole |
| 470A: cutout portion | |

### DETAILED DESCRIPTION

Some embodiments of the present disclosure are provided herein to more fully describe the present disclosure to a person skilled in the art; however, the following embodiments may be modified in various different forms, and a scope of the present disclosure is not limited to the following embodiments. The embodiments are provided to make the present disclosure more complete and to fully convey an idea of the present disclosure to a person skilled in the art.

In the drawings, a thickness or a size of each layer may be exaggerated for convenience and clarity of description, and the same reference numeral in the drawings refers to the same element. As used in the present specification, a term “and/or” includes any one of listed items and all combinations of one or more of the listed items. In addition, in the present specification, “connection” means not only a case in which an A member and a B member are directly connected, but also a case in which one or more C members are interposed between the A member and the B member to indirectly connect the A member and the B member.

A terminology used herein is used to describe a specific embodiment, and is not intended to limit the present disclosure. As used herein, a singular form may include a plural form unless the context clearly indicates otherwise. Moreover, as used herein, “comprise,” “include,” and/or “comprising,” “including” refer to specify a presence of referred shapes, numbers, steps, actions, members, elements, and/or groups thereof, and do not exclude the presence or additions of one or more other shapes, numbers, actions, members, elements, and/or groups.

In the present specification, terms such as “first” and “second” are used to describe various members, parts, regions, layers, and/or portions. However, it is to be understood that these members, parts, regions, layers, and/or portions are not to be limited by these terms. These terms are used to distinguish one member, part, region, layer, or portion from other members, parts, regions, layers, or portions. Accordingly, a first member, part, region, layer, or portion described below may refer to a second member, part, region, layer, or portion without departing from the teachings of present disclosure.

Terms related to space, such as “beneath,” “below,” “lower,” “above,” and “upper,” may be used so that one element or feature illustrated in the drawings is easily understood from other elements or features. The terms related to these spaces are for ease of understanding of the present disclosure according to various process conditions or use conditions of the present disclosure, and are not intended to limit the present disclosure. For example, if an element or feature in the drawings is inverted, the element or feature described as “bottom” or “below” will be described as “top” or “above.” Accordingly, “below” is a concept including “top” or “bottom.”

Herein, a cylinder type rechargeable battery according to one or more embodiments of the present disclosure will be described with reference to the accompanying drawings.

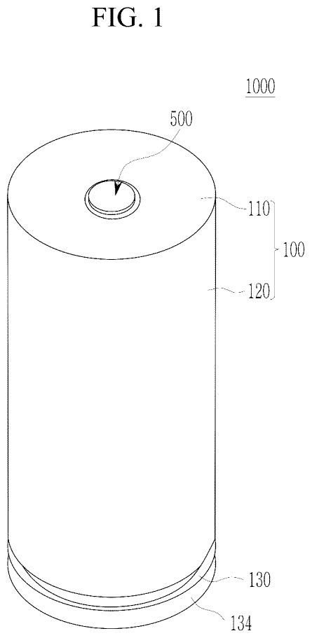

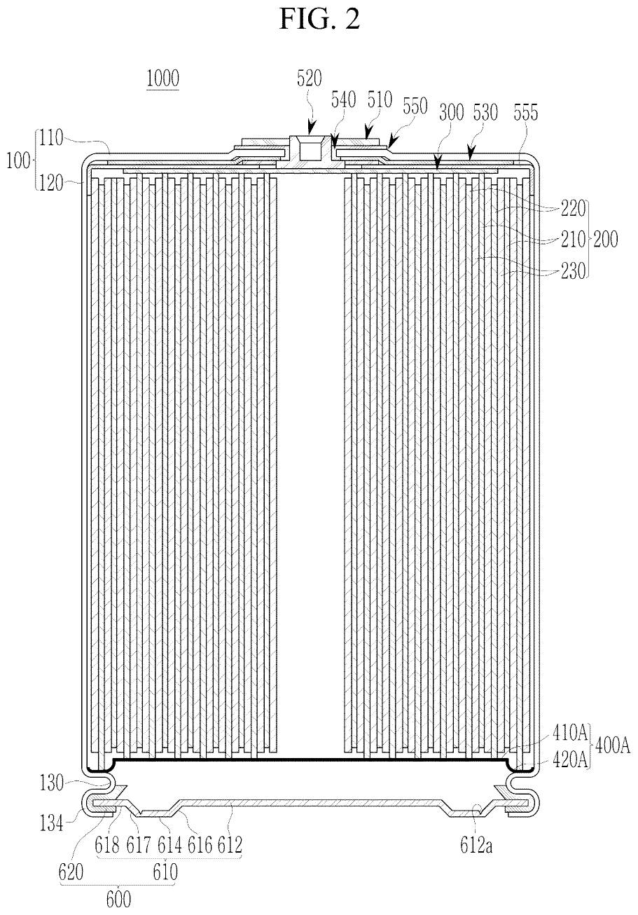

FIG. 1 is a perspective view showing a cylinder type rechargeable battery according to one or more embodiments of the present disclosure; and FIG. 2 is a cross-sectional view showing the cylinder type rechargeable battery of FIG. 1. For convenience of description, an upper side is defined as an upper direction and a lower side is defined as a lower direction based on FIG. 1 and FIG. 2.

Referring to FIG. 1 and FIG. 2, a cylinder type rechargeable battery 1000 according to one or more embodiments of the present disclosure may include a case 100 having a cylindrical shape, an electrode assembly 200 accommodated inside the case 100, a positive electrode current collecting plate 300, a negative electrode current collecting plate 400A, a terminal portion 500 disposed at a side of the case 100, and a cap assembly 600 disposed at another side of the case 100.

The case 100 may include an upper surface portion 110 having a circular band shape, a body portion 120 having a cylindrical shape extending from the upper surface portion 110, and an inlet portion 130.

Because a side of the body portion 120 has an open shape, the case 100 may have a cylindrical shape with a side open. An upper end of the body portion 120 may be connected to the upper surface portion 110. In an embodiment, for example, the body portion 120 and the upper surface portion 110 may be formed as one body.

Based on a direction shown in the drawings, a lower end of the body portion 120 may be open, and the cap assembly 600 may be installed at the open end portion.

The inlet portion 130 may be formed adjacent to the lower end of the body portion 120. The inlet portion 130 may be formed to be concave in an internal direction from the body portion 120. The electrode assembly 200 may be prevented or substantially prevented from being separated by the inlet portion 130.

A crimping portion 134 may be an end portion spaced apart from the inlet portion 130. The crimping portion 134 may extend from the body portion 120 to be bent toward an inside of the case 100.

The cap assembly 600 may be disposed between the crimping portion 134 and the inlet portion 130. The crimping portion 134 may fix the cap assembly 600 such that the case 100 is sealed.

A further detailed description of the case 100 described above will be made later while describing the negative electrode current collecting plate 400A.

In an embodiment, the case 100 with the above-described structure may be formed of steel, a steel alloy, aluminum, an aluminum alloy, or an equivalent thereof, but a material of the case 100 is not limited thereto. The electrode assembly 200, the positive electrode current collecting plate 300, and the negative electrode current collecting plate 400A may be accommodated together with an electrolyte within the case 100.

The electrolyte may enable a lithium ion generated by an electrochemical reaction to move in a first electrode and a second electrode within the battery. The electrolyte may be formed of an organic solvent, such as ethylene carbonate (EC), propylene carbonate (PC), diethyl carbonate (DEC), ethyl methyl carbonate (EMC), and/or dimethyl carbonate (DMC), and a lithium salt such as LiPF₆ or LiBF₄. The electrolyte may have a liquid phase, a solid phase, or a gel-like phase. Further details of the electrolyte may be the same as described above.

The electrode assembly 200 may have a shape in which a first electrode 210, a second electrode 220, and a separator 230 interposed therebetween are wound in a cylindrical shape. For example, the electrode assembly 200 may be wound in a jelly roll shape.

In an embodiment, the first electrode 210 may be a positive electrode, and the second electrode 220 may be a negative electrode. However, the first electrode 210 may be a negative electrode, and the second electrode 220 may be a positive electrode.

The first electrode 210 may have a positive electrode active material (e.g., a first active material) coated on at least one surface of a substrate made of a thin metal plate. For example, the substrate may be aluminum (Al), the positive electrode active material may be transition metal oxide (e.g., LiCoO₂, LiNiO₂, LiMn₂O₄, or like), and further details thereof may be the same as described above.

A first electrode uncoated portion (not shown) that is a region where a substrate is exposed because a positive electrode active material is not coated, may be provided at an edge of the first electrode 210. In an embodiment, the first electrode uncoated portion may be disposed toward the upper surface portion 110 of the case 100.

For example, the first electrode uncoated portion (not shown) may protrude upward from the separator 230 to be electrically connected to the positive electrode current collecting plate 300. The first electrode uncoated portion may also be referred to as a first tab, a first uncoated portion tab, or a first substrate tab.

The second electrode 220 may have a negative electrode active material (e.g., a second active material) coated on at least one surface of a substrate made of a thin metal plate. For example, the substrate may be copper (Cu), nickel (Ni), or an alloy of copper and nickel, and the negative electrode active material may be graphite, carbon, or the like, but further details thereof may be the same as described above.

A second electrode uncoated portion (not shown) that is a region where a substrate is exposed because a negative electrode active material is not coated, may be provided at an edge of the second electrode 220. In an embodiment, the second electrode uncoated portion may be disposed toward a lower portion of the case 100.

For example, the second electrode uncoated portion may protrude downward from the separator 230 to be electrically connected to the negative electrode current collecting plate 400A. A portion of the second electrode uncoated portion may be electrically connected to the inlet portion 130 of the case 100. The second electrode uncoated portion may also be referred to as a second tab, a second uncoated portion tab, or a second substrate tab.

The separator 230 may be polyethylene (PE) or polypropylene (PP), but embodiments are not limited thereto. The separator 230 may prevent or substantially prevent an electrical short circuit between the first electrode 210 and the second electrode 220, and may enable only movement of a lithium ion.

The electrode assembly 200 with the above-described structure may be electrically connected to the positive electrode current collecting plate 300 and the negative electrode current collecting plate 400A to be electrically connected to the terminal portion 500 and the case 100, respectively.

In an embodiment, the positive electrode current collecting plate 300 may have a disk shape, and may be manufactured from a same material as that of the first electrode 210. For example, the positive electrode current collecting plate 300 may be made of aluminum or an aluminum alloy.

The positive electrode current collecting plate 300 may have a size smaller than that of the upper surface portion 110 of the case 100. Therefore, the positive electrode current collecting plate 300 may be prevented or substantially prevented from being electrically connected to the case 100.

In an embodiment, the positive electrode current collecting plate 300 may be welded in a state in which a lower surface thereof is in contact with the first electrode uncoated portion of the first electrode 210. Thus, the positive electrode current collecting plate 300 and the first electrode 210 may be electrically connected.

For example, an upper surface of the positive electrode current collecting plate 300 may be welded to a second terminal 520 of the terminal portion 500 that will be described later. Accordingly, the positive electrode current collecting plate 300 and the second terminal 520 may be electrically connected.

Therefore, the first electrode 210 and the second terminal 520 may be electrically connected by the positive electrode current collecting plate 300. For example, the positive electrode current collecting plate 300 may be a path for a current flow between the first electrode 210 and the second terminal 520.

Although not shown in the drawings, the positive electrode current collecting plate 300 may include a short circuit prevention circuit (or a short circuit prevention means) (not shown), such as a fuse or the like. In an embodiment, the positive electrode current collecting plate 300 may include a central region in contact with the second terminal 520, a peripheral region around (e.g., surrounding) the central region and in contact with the first electrode uncoated portion, and a fuse portion between the central region and the peripheral region.

For example, a slit with an arc shape that divides the central region and the peripheral region may be formed at the positive electrode current collecting plate 300 having the disk shape, and the fuse portion may have a cross-sectional area smaller than that of the central region.

The negative electrode current collecting plate 400A may be electrically connected to the second electrode 220 of the electrode assembly 200. In an embodiment, the negative electrode current collecting plate 400A may be made of a same material as that of the second electrode 220. In an embodiment, for example, the negative electrode current collecting plate 400A may be made of copper.

The negative electrode current collecting plate 400A may be electrically connected to the body portion 120 of the case 100 described above. A portion of the negative electrode current collecting plate 400A may be welded in a state in which the portion thereof is in contact with the second electrode uncoated portion (not shown) of the second electrode 220. Accordingly, the negative electrode current collecting plate 400A and the second electrode 220 may be electrically connected. A further detailed description of the negative electrode current collecting plate 400A will be provided later.

The cap assembly 600 may include a cap plate 610 for sealing the case 100 and a gasket 620 that insulates between the case 100 and the cap plate 610.

The cap plate 610 may include a planar portion 612 having a disk shape, a first inclined surface 616 connected to the planar portion 612, and an extension surface 614 connected to the first inclined surface 616.

The planar portion 612 may be disposed generally parallel to the negative electrode current collecting plate 400A. The first inclined surface 616 may extend to be inclined downward from an edge of the planar portion 612. The extension surface 614 may extend from an edge of the inclined surface 616, and may be parallel to the planar portion 612.

The extension surface 614 may include a second inclined surface 617 extending to be inclined upward and a coupling surface 618 extending parallel to the extension surface 614 at the second inclined surface 617.

The coupling surface 618 may be disposed between the inlet portion 130 and the crimping portion 134 in a state in which the coupling surface 618 is surrounded by the gasket 620.

In an embodiment, a notch 612a may be on the extension surface 614. The notch 612a may be broken if a pressure inside the rechargeable battery 1000 is greater than or equal to a certain pressure (e.g., a predetermined pressure). A gas inside the rechargeable battery 1000 may be emitted by breaking the notch 612a. For example, the notch 612a may function as a vent.

In an embodiment, the notch 612a may be on a surface, an opposite surface, or both surfaces of the extension surface 614. In another embodiment, the notch 612a may be on a surface, an opposite surface, or both surfaces of the planar portion 612. For example, the notch 612a may be provided in a plural number.

In some embodiments, the cap plate 610 may not include the inclined surfaces 616 and 617, and may be made only of the planar portion 612 having a flat shape.

The gasket 620 may be disposed between a lower portion of the inlet portion 130 and the crimping portion 134, and may surround the coupling surface 618 of the cap plate 610. Accordingly, the gasket 620 may seal a space between the cap plate 610 and the case 100. For example, the case 100 may be sealed by the gasket 620 and the cap plate 610. The gasket 620 may surround a portion or all of the coupling surface 618.

A side where the gasket 620 and the coupling surface 618 are in contact may be defined as an inner side, and a side where the gasket 620 is in contact with the inlet portion 130 may be defined as an outer side. In this case, a portion of a contact portion 420A of the negative electrode current collecting plate 400A may be inserted between an outer upper portion of the gasket 620 and the inlet portion 130.

Accordingly, the contact portion 420A of the negative electrode current collecting plate 400A and the coupling surface 618 of the cap plate 610 may not be in contact with each other by the gasket 620. For example, the gasket 620 may mutually insulate the cap plate 610 and the case 100, and may mutually insulate the cap plate 610 and the negative electrode current collecting plate 400A.

However, the present disclosure is not limited thereto, and, in some embodiments, the coupling surface 618 of the cap plate 610 may be in contact with the negative electrode current collecting plate 400A or the case 100. However, in the embodiments, the gasket 620 may perform a function of sealing the cap plate 610 and the case 100.

As described above, the positive electrode current collecting plate 300 and the negative electrode current collecting plate 400A may be electrically connected to the electrode assembly 200. For example, the positive electrode current collecting plate 300 may be electrically connected to the terminal portion 500 (or the second terminal 520), and the negative electrode current collecting plate 400A may be electrically connected to the case 100. Therefore, the second terminal 520 may have a positive electrode polarity, and the case 100 may have a negative electrode polarity.

For example, the terminal portion 500 may include a first terminal 510, the second terminal 520, and first to third insulating members 530, 540, and 550.

For example, the first terminal 510 may be a plate having a disk shape. The first terminal 510 may be referred to as a terminal plate. The first terminal 510 may be disposed outside the upper surface portion 110 of the case 100, and may be coupled to the second terminal 520. The first terminal 510 may be made of a same material as that of the second terminal 520. For example, the first terminal 510 may be aluminum or an aluminum alloy.

In an embodiment, after the first terminal 510 and the second terminal 520 are coupled, upper surfaces of the first terminal 510 and the second terminal 520 may be disposed on a same plane. A bus bar may be electrically connected to an upper surface that is finally formed after the first terminal 510 and the second terminal 520 are coupled.

The second terminal 520 may have a generally cylindrical shape, and may be referred to as a rivet terminal. In an embodiment, the second terminal 520 may be coupled to the first terminal 510 and the upper surface portion 110 of the case 100 in a riveting manner. In an embodiment, the second terminal 520 may be made of a same material as those of the first terminal 510 and the positive electrode current collecting plate 300. For example, the second terminal 520 may be aluminum or an aluminum alloy.

The first terminal 510 and the second terminal 520 described above may be insulated from the upper surface portion 110 of the case 100 by the first insulating member 530, the second insulating member 540, and the third insulating member 550.

The first insulating member 530 may be disposed between the upper surface portion 110 of the case 100 and the second terminal 520 to insulate the upper surface portion 110 and the second terminal 520. For example, the first insulating member 530 may be disposed inside the case 100. The first insulating member 530 may have a shape corresponding to a stepped shape of the upper surface portion 110.

In an embodiment, an insulating cover 555 may be disposed between the first insulating member 530 and the positive electrode current collecting plate 300.

The insulating cover 555 may be made of an electrically insulating material, and may cover a portion of the upper surface of the positive electrode current collecting plate 300. In some embodiments, the insulating cover 555 may cover a region of the upper surface of the positive electrode current collecting plate 300 except for a central portion that is a portion in contact with the second terminal 520.

For example, the insulating cover 555 may extend from the upper surface of the positive electrode current collecting plate 300 to cover a portion of a side surface of the electrode assembly 200. In an embodiment, a cutout portion may be formed at an end portion of the insulating cover 555 such that the end portion of the insulating cover 555 may be easily bent along the side surface of the electrode assembly 200.

Accordingly, the insulating cover 555 may prevent or substantially prevent the electrode assembly 200 (or the positive electrode current collecting plate) and the case 100 from being electrically conducted to each other. In some embodiments, the insulating cover 555 may include an insulating tape, but the present disclosure is not limited thereto. In some embodiments, the insulating cover 555 may include an injection-molded product having a shape of a cap or a cup.

The above-described first to third insulating members 530, 540, and 550 may be formed of a same material or different materials. In some embodiments, the third insulating member 550 and the first insulating member 530 may include an insulating material that has a higher heat resistance temperature than that of the second insulating member 540. In some embodiments, the second insulating member 540 may include an insulating material that has a higher heat resistance temperature than those of the first insulating member 530 and the third insulating member 550.

A manufacturing process of the cylinder type rechargeable battery according to some embodiments of the present disclosure described above will be briefly described.

First, the upper surface portion 110 may be disposed at an upper side. Thereafter, a support jig (not shown) for pressure support may be installed inside the case 100, and a pressure may be applied from the outside of the case 100 to couple the second terminal 520 to the first terminal 510 and the case 100. Accordingly, the terminal portion 500 may be fixed to the case 100.

Next, the upper surface portion 110 may be disposed at a lower side. Next, the positive electrode current collecting plate 300, the electrode assembly 200, and the negative electrode current collecting plate 400A may be inserted into the case 100. The positive electrode current collecting plate 300 and the electrode assembly 200 may be electrically connected to the first terminal 510.

Next, the inlet portion 130 may be formed after the electrolyte is filled inside the case 100. The negative electrode current collecting plate 400A may be electrically connected to the inlet portion 130. Next, the cap plate 610 may be disposed above the inlet portion 130 via the gasket 620, and the crimping portion 134 may be formed.

Separation of the electrode assembly 200 and the negative electrode current collecting plate 400A may be prevented or substantially prevented by the inlet portion 130. For example, the cap assembly 600 may be fixed to the case 100 by the crimping portion 134.

According to the above-described process, the upper surface portion 110 of the case 100 may have a negative electrode polarity, and the terminal portion 500 may have a positive electrode polarity. For example, the rechargeable battery 1000 including both the positive electrode and the negative electrode may be formed at an upper side of the case 100. However, the above-described process order is provided as an arbitrary order, and each process order may be changed or concurrently (e.g., simultaneously) performed.

Herein, a cylinder type rechargeable battery according to some embodiments will be described with reference to the drawings. The cylinder type rechargeable battery of the embodiments described below may include an electrode assembly having a shape different from that of the embodiments described above.

In the present embodiment, the above-described embodiments may be applied in the same manner to a configuration other than the electrode assembly, and a further detailed description of the configuration other than the electrode assembly is omitted.

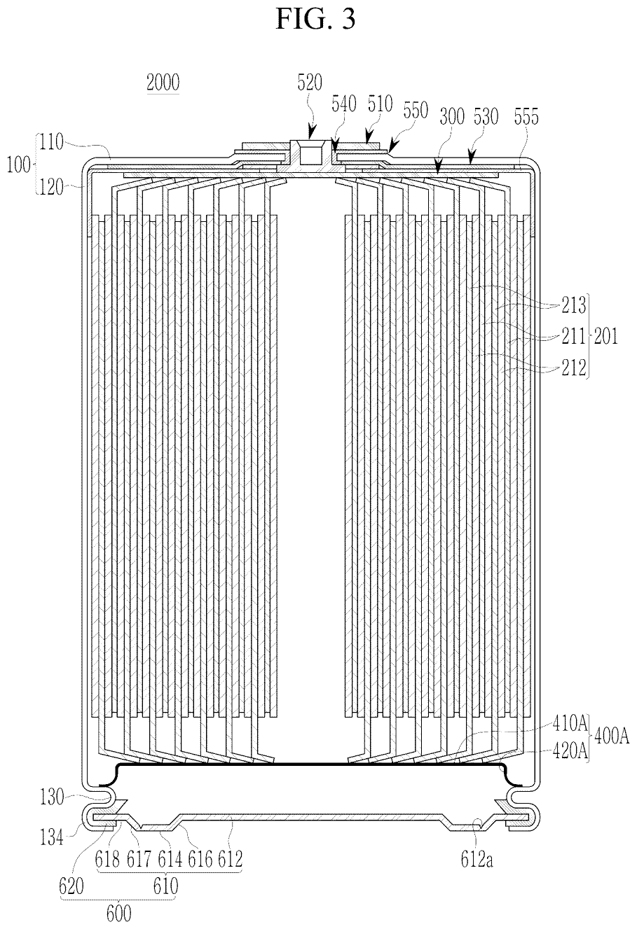

FIG. 3 is a cross-sectional view showing a cylinder type rechargeable battery including an electrode assembly according to one or more embodiments of the present disclosure.

Referring to FIG. 3, a cylinder type rechargeable battery 2000 according to the present embodiment may include an electrode assembly 201.

The electrode assembly 201 may include a first electrode 211, a separator 212, and a second electrode 213 that are sequentially stacked. The electrode assembly 201 may have a shape in which the first electrode 211, the separator 212, and the second electrode 213 are stacked and then are wound in a cylindrical shape. For example, the electrode assembly 201 may be wound in a jelly roll shape.

The first electrode 211 may include a first electrode active portion in which an active material layer (for example, a transition metal oxide (e.g., LiCoO₂, LiNiO₂, LiMn₂O₄, or like)) is formed on at least one surface of a substrate (for example, aluminum), and a first electrode uncoated portion that is a region where a substrate is exposed because an active material layer is not formed and is formed at an edge along the electrode active portion. An end portion of the active material layer may be covered with an insulating layer or the like, and the first electrode uncoated portion may be a portion made of a substrate in which another layer (e.g., the active material layer or an insulating layer) is not formed.

The second electrode 213 may include a second electrode active portion in which an active material layer (for example, graphite, carbon, or the like) is formed on at least one surface of a substrate (for example, copper, nickel, or an alloy of copper and nickel), and a second electrode uncoated portion that is a region where a substrate is exposed because an active material layer is not formed and is formed at an edge along the electrode active portion. An end portion of the active material layer may be covered with an insulating layer or the like, and the second electrode uncoated portion may be a portion made of a substrate in which another layer (e.g., the active material layer or an insulating layer) is not formed.

The cylinder type rechargeable battery 1000 according to embodiments of the present disclosure is not necessarily limited to the above-described structure, and may be applied to various cylinder type rechargeable batteries including the negative electrode current collecting plate 400A and the case 100.

Herein, the case 100 and the negative electrode current collecting plate 400A of the cylinder type rechargeable battery 1000 according to embodiments of the present disclosure will be described in further detail with reference to the drawings.

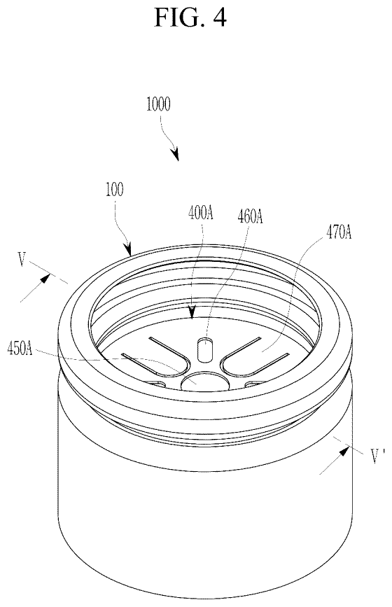

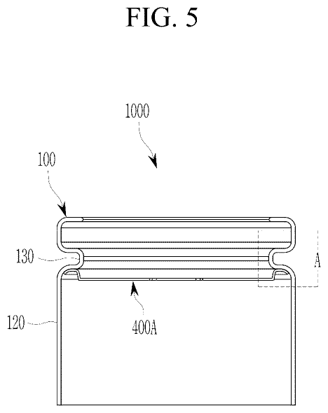

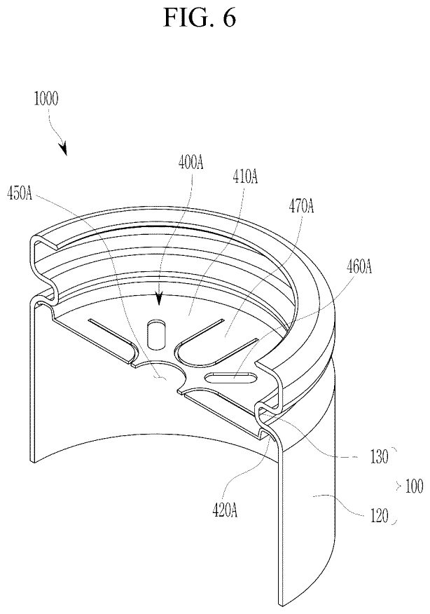

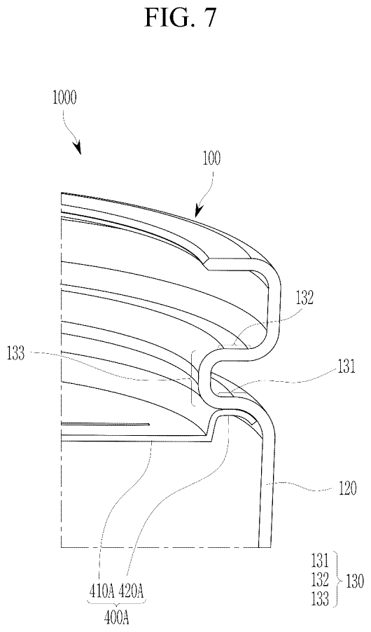

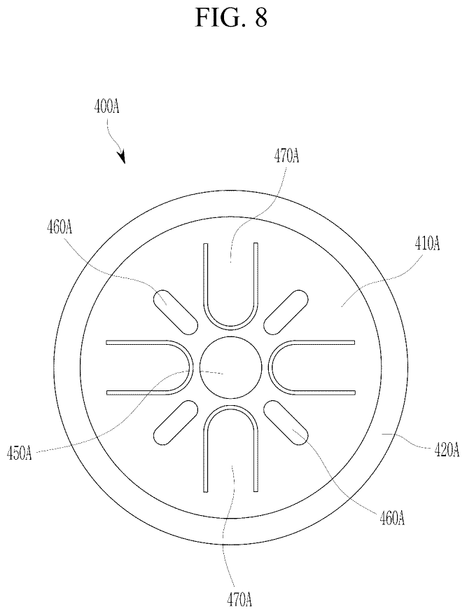

FIG. 4 is a perspective view showing a case and a negative electrode current collecting plate extracted from the cylinder type rechargeable battery according to one or more embodiments of the present disclosure; FIG. 5 is a cross-sectional view taken along the line V-V′ in the cylinder type rechargeable battery of FIG. 4; FIG. 6 is a cross-sectional view showing the cylinder type rechargeable battery of FIG. 5; FIG. 7 is an enlarged cross-sectional view of a region “A” of the cylinder type rechargeable battery of FIG. 5; and FIG. 8 is a plan view showing the negative electrode current collecting plate extracted from FIG. 4. For convenience of description, the cylinder type rechargeable battery 1000 shown in FIG. 2 is turned upside down in a vertical direction in FIGS. 4 to 8.

Referring to FIGS. 4 to 8, in the cylinder type rechargeable battery 1000 according to one or more embodiments of the present disclosure, the case 100 may include the body portion 120 and the inlet portion 130 described above.

The body portion 120 may have a cylindrical shape, and may accommodate the electrode assembly 200. The positive electrode current collecting plate 300 may be installed at a side of the body portion 120, and the negative electrode current collecting plate 400A that will be described later may be installed at another side of the body portion 120.

The inlet portion 130 may be introduced (or inserted), or extend, into the inside of the body portion 120, and a portion of the inlet portion 130 may have a shape of a plane. In an embodiment, after the electrode assembly 200 of FIG. 2 is inserted through an open end of the body portion 120, the case 100 may be processed through a separate process to generate the inlet portion 130, but a method of installing the electrode assembly is not limited to the above-described method.

For example, the inlet portion 130 may include a first flat portion 131, a second flat portion 132, and a connection portion 133.

The first flat portion 131 and the second flat portion 132 may be disposed such that outer surfaces thereof face each other. In an embodiment, the first flat portion 131 and the second flat portion 132 may be disposed to be spaced apart from each other by a distance (e.g., a predetermined distance) in a parallel state. In an embodiment, each of the first flat portion 131 and the second flat portion 132 may have a planar shape.

Welding may be performed in a state where a portion of the negative electrode current collecting plate 400A that will be described later is in contact with any one of the first flat portion 131 and the second flat portion 132. In an embodiment, widths of the first flat portion 131 and the second flat portion 132 may be approximately 0.1 mm to 1 mm, but the present disclosure is not limited thereto.

The connection portion 133 may connect the first flat portion 131 and the second flat portion 132. In an embodiment, an overall shape of the inlet portion 130 may have a “U” shape.

As described above, in the cylinder type rechargeable battery 1000 according to embodiments of the present disclosure, the negative electrode current collecting plate 400A may be electrically connected to the electrode assembly 200. For example, the negative electrode current collecting plate 400A may include a base portion 410A and a contact portion 420A.

A portion of the base portion 410A may be connected to the electrode assembly 200. The base portion 410A may have a disk shape. A surface of the base portion 410A may be fixed and electrically connected to the negative electrode plate 220 exposed from the electrode assembly 200 by welding in a state in which the negative electrode plate 220 is in contact with a lower surface of the electrode assembly 200.

The contact portion 420A may extend from an edge of the base portion 410A toward the inlet portion 130, and may contact a portion shaped as a plane of an inner surface of the case 100. The contact portion 420A may have an arc shape. The contact portion 420A may have a shape corresponding to that of the inlet portion 130 so as to be in contact with the above-described inlet portion 130 without a gap.

For example, a welding method between the contact portion 420A and the inlet portion 130 of the case 100 may be welded from the outside of the case 100 after the case 100 is sealed. For example, the welding may be performed at portions of the first flat portion 131 and the second flat portion 132 of the inlet portion 130 that are in contact with the contact portion 420A. As described above, the welding may be performed on a flat surface rather than a curved surface, such that the welding is performed more stably.

In the present embodiment, the negative electrode current collecting plate 400A may not be electrically connected to the cap assembly 600 described above. However, the present disclosure is not limited thereto, and, in an embodiment, the negative electrode current collecting plate 400A may be electrically connected to the cap assembly 600, and the cap assembly 600 may have a same polarity as that of the second electrode 220.

In an embodiment, although not shown in the drawings, if welding is performed in the first flat portion 131, a portion where the welding is performed may be four or more regions. For example, if there are four welding regions, each region may be disposed at 90 degrees apart, or every 90 degrees, based on a center of the base portion 410A in the first flat portion 131. In an embodiment, for example, a length at which the welding is performed for each region may be approximately 4 mm, but the present disclosure is not limited thereto.

After the welding process is performed, rust may be prevented or substantially prevented from occurring by performing a rust prevention process on the inlet portion 130.

In a manufacturing process of a conventional cylinder type rechargeable battery, a case and a current collecting plate are welded inside the rechargeable battery. Therefore, a foreign substance generated during the welding may occur inside the case. A resistance may increase due to the foreign substance.

However, in the cylinder type rechargeable battery 1000 according to the embodiments of the present disclosure, the contact portion 420A of the negative electrode current collecting plate 400A may contact the inlet portion 130 of the case 100 such that welding is performed from the outside. Accordingly, the welding may be performed from the outside, such that a foreign substance is prevented or substantially prevented from occurring inside the case 100. In addition, it is possible to prevent or substantially prevent a resistance of the cylinder type rechargeable battery 1000 from being increased by the foreign substance.

Therefore, it is possible to improve productivity and reduce a manufacturing cost by reducing a manufacturing defect rate of the cylinder type rechargeable battery 1000.

A first through hole 450A may be disposed in the negative electrode current collecting plate 400A described above. The first through hole 450A may be disposed at a central portion of the negative electrode current collecting plate 400A, and may be formed to penetrate the base portion 410A. The electrolyte may be injected through the first through hole 450A.

At least one second through hole 460A may be disposed in the negative electrode current collecting plate 400A described above. The electrolyte may be injected through the second through hole 460A. In an embodiment, the at least one second through hole 460A may be disposed or spaced apart at an angle or interval (e.g., a predetermined angle or interval) based on a central portion of the base portion 410A, and may be formed to penetrate the base portion 410A.

In an embodiment, for example, the negative electrode current collecting plate 400A may include four second through holes 460A. In an embodiment, the four second through holes 460A may be disposed or spaced apart at 90 degrees based on a central portion of the base portion 410A. In an embodiment, the second through hole 460A may have a slot shape.

The base portion 410A of the negative electrode current collecting plate 400A may be welded to the negative electrode plate of the electrode assembly. Therefore, the base portion 410A may require a large area for the welding. If the second through hole 460A has a circular shape rather than the slot shape, an area required for the welding may be insufficient such that the welding between the base portion 410A and the negative electrode plate may be difficult.

However, in the cylinder type rechargeable battery 1000 according to the embodiments of the present disclosure, the second through hole 460A of the negative electrode current collecting plate 400A may have the slot shape, such that an area required for the welding with the negative electrode plate in the base portion 410A is secured as much as possible.

The electrolyte may be injected not only through the first through hole 450A but also through the second through hole 460A. Accordingly, the second through hole 460A may increase an impregnation speed of the electrolyte, such that it improves an impregnation property compared with a conventional cylinder type rechargeable battery.

In an embodiment, the negative electrode current collecting plate 400A may include at least one cutout portion 470A.

The cutout portion 470A may be cut from a portion of the base portion 410A, and may be connected to the negative electrode plate of the electrode assembly. The negative electrode plate and the cutout portion 470A may be connected by welding.

In an embodiment, the negative electrode current collecting plate 400A may include four cutout portions 470A. In an embodiment, the four cutout portions 470A may be disposed or spaced at every 90 degrees based on a center of the base portion 410A. In an embodiment, the cutout portion 470A may be formed by cutting a portion of the base portion 410A in a “U” shape.

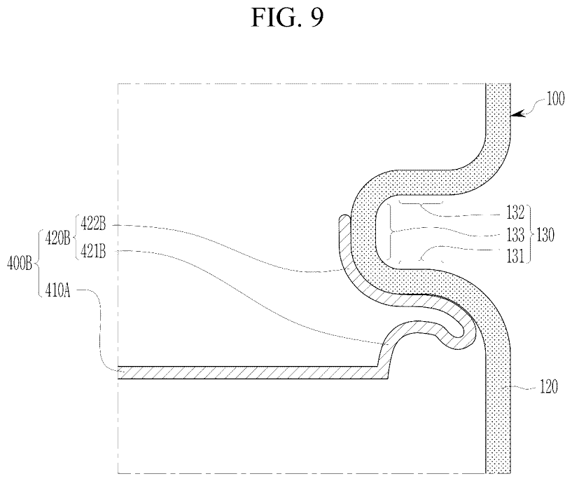

FIG. 9 is a cross-sectional view showing a negative electrode current collecting plate according to one or more embodiments of the present disclosure.

Referring to FIG. 9, a contact portion 420B included in the negative electrode current collecting plate 400B according to an embodiment may include a first elastic portion 421B and a second elastic portion 422B.

The first elastic portion 421B may extend from an edge of the base portion 410A toward the inlet portion 130.

The second elastic portion 422B may extend from the first elastic portion 421B, may contact a portion having a shape of a plane at the inlet portion 130, and may surround at least a portion of the inlet portion 130. For example, the second elastic portion 422B may be configured to not only cover any of the first flat portion 131 and the second flat portion 132 but also cover the connection portion 133.

Each of the first elastic portion 421B and the second elastic portion 422B may formed of an elastically deformable material.

The contact portion 420B described above may be welded in a state in which it simply contacts any selected from the from the first flat portion 131 and the second flat portion 132. However, in an embodiment, as described above, the contact portion 420B according to the modified example may be spanned over the inlet portion 130 by an elastic force. Thereafter, while welding is performed outside the case 100, the contact portion 420B and the inlet portion 130 may be coupled to each other.

In this case, the contact portion 420B of the negative electrode current collecting plate 400B according to the present embodiment may also be in contact with the connection portion 133 of the inlet portion 130. Therefore, it may be possible for welding to be performed not only at the first flat portion 131 or the second flat portion 132 but also at the connection portion 133. The welding may be performed relatively easily and accurately when the welding is performed at a recessed connection portion 133 compared to when the welding is performed at the first flat portion 131 or the second flat portion 132 that has a planar shape.

For example, the contact portion 420B of the negative electrode current collecting plate 400B according to the present embodiment may have an increased contact area with the inlet portion 130 compared with the contact portion 420A of the negative electrode current collecting plate 400A of FIG. 7 such that a coupling force is improved.

Although some embodiments of the present disclosure have been described herein, the drawings and the detailed description described above are merely illustrative, are provided for describing the present disclosure, and are not intended to limit a meaning or a scope of the present disclosure disclosed in the claims. Therefore, a person skilled in the art will understand that various modifications and other equivalent embodiments may be derived therefrom. Thus, a protection scope of the present disclosure is to be determined by a technical idea of the appended claims.

What is claimed is:

1. A cylinder type rechargeable battery, comprising:
an electrode assembly;
a case comprising a body portion and an inlet portion extending into the body portion and having a portion shaped as a plane, the case accommodating the electrode assembly; and
a negative electrode current collecting plate comprising a base portion comprising a portion connected to the electrode assembly and a contact portion extending from an edge of the base portion toward the inlet portion and contacting the portion shaped as the plane of an inner surface of the case, the negative electrode current collecting plate being electrically connected to the electrode assembly.

2. The cylinder type rechargeable battery as claimed in claim 1, wherein the contact portion comprises:
a first elastic portion extending from an edge of the base portion toward the inlet portion; and
a second elastic portion extending from the first elastic portion, contacting the portion shaped as a plane of the inlet portion, and covering at least a portion of the inlet portion.

3. The cylinder type rechargeable battery as claimed in claim 2, wherein each of the first elastic portion and the second elastic portion comprises an elastically deformable material.

4. The cylinder type rechargeable battery as claimed in claim 1, wherein the negative electrode current collecting plate further comprises a first through hole located at a central portion of the negative electrode current collecting plate and penetrating the base portion.

5. The cylinder type rechargeable battery as claimed in claim 1, wherein the negative electrode current collecting plate further comprises at least one second through hole located at an angle based on a central portion of the base portion and penetrating the base portion.

6. The cylinder type rechargeable battery as claimed in claim 5, wherein the at least one second through hole has a slot shape.

7. The cylinder type rechargeable battery as claimed in claim 5, wherein the at least one second through hole comprises four second through holes, and the four second through holes are located at 90 degrees apart based on the central portion of the base portion.

8. The cylinder type rechargeable battery as claimed in claim 1, wherein the negative electrode current collecting plate comprises at least one cutout portion that is cut from a portion of the base portion and is connected to a negative electrode plate of the electrode assembly.

9. The cylinder type rechargeable battery as claimed in claim 8, wherein the at least one cutout portion comprises four cutout portions, and the four cutout portions are located at 90 degrees apart based on a center of the base portion.

10. The cylinder type rechargeable battery as claimed in claim 8, wherein the at least one cutout portion is formed by cutting a portion of the base portion in a “U” shape.

11. The cylinder type rechargeable battery as claimed in claim 1, wherein the inlet portion of the case comprises:
a first flat portion and a second flat portion that are located such that outer surfaces thereof face each other; and
a connection portion that connects the first flat portion and the second flat portion.

12. The cylinder type rechargeable battery as claimed in claim 1, wherein the contact portion has an arc shape.
